(19) United States
(12) Patent Application Publication
(10) Pub. No.: US 2013/0286435 A1
(43) Pub. Date: Oct. 31, 2013

(54) IMAGE PROCESSING APPARATUS, METHOD FOR CONTROLLING THE SAME, AND RECORDING MEDIUM

(71) Applicant: KONICA MINOLTA, INC., Chiyoda-ku (JP)

(72) Inventors: Kazuya Anezaki, Amagasaki-shi (JP); Hiroaki Sugimoto, Nagoya-shi (JP); Shuji Yoneda, Osaka-shi (JP); Hidetaka Iwai, Itami-shi (JP); Takeshi Maekawa, Amagasaki-shi (JP)

(73) Assignee: Konica Minolta, Inc., Chiyoda-ku (JP)

(21) Appl. No.: 13/866,465

(22) Filed: Apr. 19, 2013

(30) Foreign Application Priority Data
Apr. 27, 2012 (JP) 2012-102619

(51) Int. Cl. H04N 1/00

(52) U.S. Cl. CPC H04N 1/00381
USPC 358/1.15

(57) ABSTRACT

A processing device of an image processing apparatus recognizes contents of a touch operation when the touch operation onto an operation panel is performed, obtains an operation item stored in association with the contents of the touch operation, carries out control at the time of selection of the obtained operation item, and then presents on the operation panel, the contents of the touch operation stored in association with the obtained item.

This application is based on Japanese Patent Application No. 2012-102619 filed with the Japan Patent Office on Apr. 27, 2012, the entire content of which is hereby incorporated by reference.

### BACKGROUND OF THE INVENTION

1. Field of the Invention

The present disclosure relates to control of an image processing apparatus including an operation panel.

2. Description of the Related Art

Various techniques have conventionally been proposed in connection with customization of an operation screen displayed on an operation panel of an image processing apparatus. For example, Japanese Laid-Open Patent Publication No. 2010-045423 discloses a technique for changing a manner of display of help information displayed in a help screen based on information for customizing an operation screen.

### SUMMARY OF THE INVENTION

There is a case, however, that a plurality of users make use of a single image processing apparatus. With the conventional technique described above, if there is a user who is not aware of setting contents for customization of an operation screen in the image processing apparatus among the plurality of users, such a situation that a degree of benefits enjoyed as a result of customization of the operation screen is different among the users is assumed.

The present disclosure was made up in view of such circumstances, and an object thereof is to achieve improvement in usability of an image processing apparatus for a greater number of users.

According to one aspect, an image processing apparatus is provided. The image processing apparatus includes an image processing unit configured to realize a function for image processing, an operation panel accepting an operation instruction to the image processing unit, and a processing device configured to control an operation of the image processing unit and the operation panel. The processing device is configured to recognize contents of a touch operation when the touch operation is performed onto the operation panel, obtain an operation item stored in association with the contents of the touch operation, carry out control at the time when the obtained operation item is selected, and present on the operation panel, the contents of the touch operation stored in association with the obtained item.

Preferably, the processing device is configured to display the contents of the touch operation on the operation panel, together with a message inviting reproduction of the contents of the touch operation.

Preferably, the processing device is configured to display the contents of the touch operation on the operation panel, together with information specifying the operation item.

Preferably, display of the contents of the touch operation is display of a motion picture for displaying the contents of the touch operation over time.

Preferably, the processing device is configured to detect a speed of the touch operation when the touch operation is performed onto the operation panel and obtain an operation item stored in association with the contents and the speed of the touch operation, and to carry out control at the time when the obtained operation item is selected.

Preferably, the processing device is configured to further display contents of a touch operation for enlarging a region for displaying information relating to an operation item on the operation panel, when an area of the region is smaller than a predetermined area.

According to another aspect, a method for controlling an image processing apparatus is provided. The control method is a method for controlling an image processing apparatus including an image processing unit configured to realize a function for image processing and an operation panel accepting an operation instruction to the image processing unit, which is performed by a computer of the image processing apparatus. The control method includes the computer recognizing contents of a touch operation when the touch operation is performed onto the operation panel, the computer obtaining an operation item associated with the contents of the recognized touch operation, the computer carrying out control at the time when the obtained operation item is selected, and the computer presenting the contents of the touch operation stored in association with the obtained operation item.

Preferably, the control method further includes the computer causing the operation panel to display the contents of the touch operation, together with a message inviting reproduction of the contents of the touch operation.

Preferably, the control method further includes the computer causing the operation panel to display the contents of the touch operation, together with information specifying the operation item.

Preferably, display of the contents of the touch operation is display of a motion picture for displaying the contents of the touch operation over time.

Preferably, the control method further includes the computer detecting a speed of the touch operation when the touch operation is performed onto the operation panel and obtaining an operation item stored in association with the contents and the speed of the touch operation, and the computer carrying out control at the time when the obtained operation item is selected.

Preferably, the control method further includes the computer providing further display of contents of a touch operation for enlarging a region for displaying information relating to an operation item on the operation panel, when an area of the region is smaller than a predetermined area.

According to yet another aspect, a computer-readable recording medium is provided. The recording medium records in a non-transitory manner, a control program as described above, which is executable by a computer of an image processing apparatus including an image processing unit for realizing a function for image processing and an operation panel for accepting an operation instruction to the image processing unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing appearance of one embodiment of an image processing apparatus.

FIG. 2 is a diagram showing a block configuration of the image processing apparatus.

FIG. 3 is a diagram schematically showing one example of contents in a gesture registration table stored in a storage portion.

FIG. 4 is a diagram showing transition of display contents on a touch panel in registering a gesture.

FIG. 5 is a flowchart of processing performed by a control unit for processing described with reference to FIG. 4.

FIGS. 6 to 8 are diagrams for illustrating display of a gesture.

FIG. 9 is a flowchart of gesture display processing performed by the control unit.

FIG. 10 is a diagram for illustrating registration of a gesture in a variation (1) of the image processing apparatus.

FIG. 11 is a flowchart of gesture registration processing in accordance with variation (1) of the image processing apparatus.

FIG. 12 is a flowchart of gesture display processing in accordance with variation (1) of the image processing apparatus.

FIG. 13 is a diagram schematically showing one example of contents in a gesture registration table in a variation (2) of the image processing apparatus.

FIG. 14 is a diagram for illustrating registration of a gesture in variation (2) of the image processing apparatus.

FIG. 15 is a diagram for illustrating display of a gesture in variation (2) of the image processing apparatus.

FIG. 16 is a flowchart of gesture registration processing performed in variation (2) of the image processing apparatus.

FIG. 17 is a flowchart of gesture display processing performed in variation (2) of the image processing apparatus.

FIG. 18 is a diagram for illustrating display of a gesture in a variation (3) of the image processing apparatus.

FIG. 19 is a flowchart of gesture display processing performed in variation (3) of the image processing apparatus.

### DESCRIPTION OF THE PREFERRED EMBODIMENTS

An embodiment of an image processing apparatus will be described hereinafter with reference to the drawings. It is noted that a constituent element having the same action and function in each figure has the same reference character allotted and description thereof will not be repeated.

[Exterior Configuration of Image Processing Apparatus]

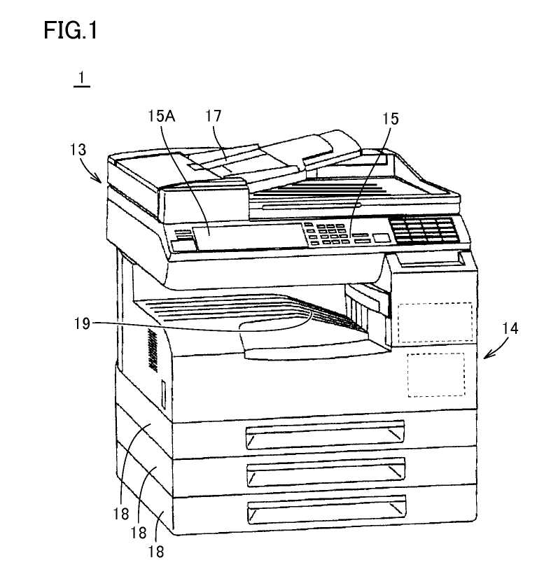

An exterior configuration of an image processing apparatus will be described with reference to FIG. 1. FIG. 1 is a diagram showing appearance of one embodiment of the image processing apparatus.

As shown in FIG. 1, an image processing apparatus 1 includes an operation portion 15 for inputting an operation instruction and characters and numbers to image processing apparatus 1. In addition, image processing apparatus 1 includes a scanner portion 13 and a printer portion 14. Scanner portion 13 obtains image data by photoelectrically scanning a document. Printer portion 14 prints an image on a sheet of paper based on the image data obtained by scanner portion 13 or image data received from external equipment connected through a network.

Image processing apparatus 1 includes a feeder portion 17 feeding a document to scanner portion 13 on an upper surface of its main body. Image processing apparatus 1 includes a paper feed portion 18 supplying paper to printer portion 14 in a lower portion of the main body. Image processing apparatus 1 further includes, in a central portion thereof, a tray 19 to which paper having an image printed thereon by printer portion 14 is ejected.

Operation portion 15 is provided with a touch panel 15A for display and input of information. Image processing apparatus 1 is implemented, for example, by an MFP (Multi-Functional Peripheral) having a plurality of functions such as a copy function, a facsimile function, and a scanner function. It is noted that the image processing apparatus according to the present embodiment does not have to have all these functions and it only has to have at least one of these functions.

[Internal Configuration of Image Processing Apparatus]

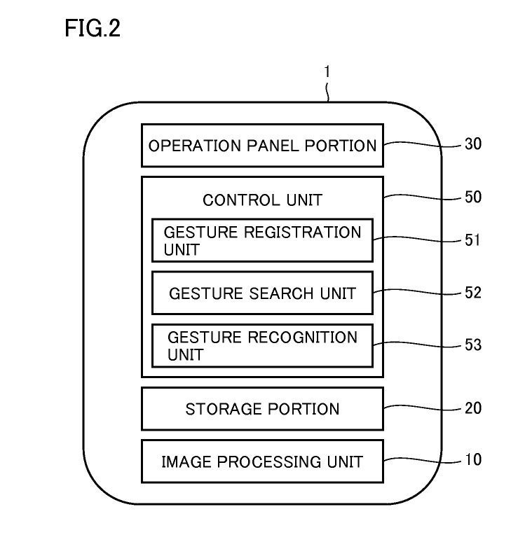

An internal configuration of image processing apparatus 1 will be described with reference to FIG. 2. FIG. 2 is a diagram showing a block configuration of image processing apparatus 1.

As shown in FIG. 2, image processing apparatus 1 includes a control unit 50 generally controlling an operation of image processing apparatus 1. Control unit 50 includes a processor such as a CPU (Central Processing Unit) and a general configuration mounted on a computer such as a ROM (Read Only Memory) made use of for execution of a program by the processor, an S-RAM (Static Random Access Memory), an NV-RAM (Non Volatile Random Access Memory), and a clock IC (Integrated Circuit). The NV-RAM above stores data of initial setting or the like of image processing apparatus 1.

Image processing apparatus 1 further includes an operation panel portion 30 controlling operation portion 15, a storage portion 20 storing various types of data such as a program executed by the processor above, and an image processing unit 10 which is an engine portion for realizing at least one of image processing functions described above.

A program executed by the processor above may be stored in a permanent memory of storage portion 20 at the time of shipment of image processing apparatus 1 or the like or may be downloaded via a network and stored in the permanent memory. Alternatively, a program may be stored in a storage medium attachable to and removable from image processing apparatus 1 so that the processor above reads the program from the storage medium and executes the program. Examples of storage media include media storing a program in a non-volatile manner, such as a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, a magnetic tape, a cassette tape, an MO (Magnetic Optical disc), an MID (Mini Disc), an IC (Integrated Circuit) card (except for memory cards), an optical card, a mask ROM, an EPROM, an EEPROM (Electronically Erasable Programmable Read-Only Memory), and the like.

Image processing unit 10 may include an image scanning apparatus and an image output apparatus. The image scanning apparatus is a mechanism for scanning a document image and generating image data, and includes scanner portion 13 and feeder portion 17. The image output apparatus is a mechanism for printing image data on a sheet of paper and includes printer portion 14. Image processing unit 10 may further include a printer controller. The printer controller controls timing of printing or the like of the image output apparatus.

Operation panel portion 30 includes operation portion 15 and a circuit for controlling the same. Operation portion 15 includes a hardware key group provided in the main body of image processing apparatus 1 and touch panel 15A. It is noted that operation portion 15 may also be configured to be attachable to and removable from the main body of image processing apparatus 1. In this case, operation panel portion 30 includes a circuit for realizing wireless communication between operation portion 15 and the main body of image processing apparatus 1.

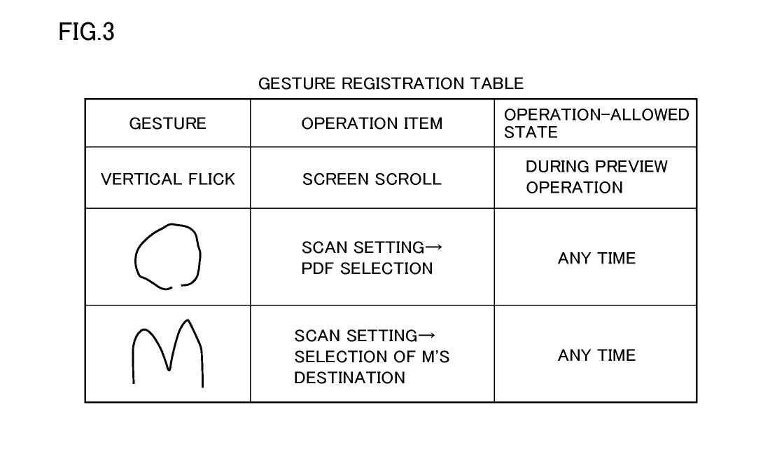

Control unit 50 includes as functions, a gesture registration unit 51, a gesture search unit 52, and a gesture recognition unit 53. Gesture registration unit 51 registers a gesture or the like in a gesture registration table (FIG. 3) which will be described later. Gesture search unit 52 searches for whether or not a designated gesture has already been registered in the gesture registration table. Gesture recognition unit 53 identifies whether or not an operation performed onto touch panel 15A has been registered in the gesture registration table. At least a part of gesture registration unit 51, gesture search unit 52, and gesture recognition unit 53 may be implemented by execution of a specific program by the CPU above or implemented by dedicated hardware (a circuit or the like).

In image processing apparatus 1, control unit 50 instructs image processing unit 10 to perform an image processing operation based on information received through a network. Control unit 50 may have a function to communicate with other apparatuses through a network. When an operation is performed through operation portion 15, control unit 50 instructs image processing unit 10 to perform an image processing operation corresponding to operation contents.

In image processing apparatus 1, contents of processing to be performed by image processing unit 10 are registered in association with a gesture on touch panel 15A. The gesture means contents of a touch operation, and may include a path of movement of a touch position and contents of the touch operation (single click, double click, flick, etc.).

In image processing apparatus 1, a specific image processing operation may be realized by successively selecting a menu displayed on touch panel 15A or a specific image processing operation may be realized also by a touch operation onto touch panel 15A in accordance with a gesture already registered in image processing apparatus 1.

[Gesture Registration Table]

FIG. 3 is a diagram schematically showing one example of contents in a gesture registration table stored in storage portion 20. In the gesture registration table, contents of processing performed by image processing unit 10 are registered in association with a gesture.

Referring to FIG. 3, in the gesture registration table, a “gesture”, an “operation item”, and an “operation-allowed state” are associated with one another. The “gesture” is information specifying contents of an operation onto touch panel 15A. In FIG. 3, a character string “vertical flick”, a substantially circular graphic, a graphic of handwritten character “M” are exemplified. In image processing apparatus 1, some contents of an operation to be registered are exemplified by contents selected from among the contents registered in advance in image processing apparatus 1 and contents of operation (a drawing operation) performed onto touch panel 15A by a user and stored as they are. Vertical flick means a flicking operation in a vertical direction of touch panel 15A. In this case, “vertical” means, for example, a vertical direction in a case where a user visually recognizes touch panel 15A in such a position that the user is normally supposed to operate touch panel 15A set in a specific orientation.

The “operation item” refers to information specifying operation contents for an image processing operation, which are realized by image processing unit 10. In FIG. 3, “screen scroll”, “scan setting * PDF selection,” and “scan setting * selection of M's destination” are exemplified (“*” represents an arrow in FIG. 3; the same shall apply hereinafter).

The “screen scroll” means processing for scrolling contents of display on touch panel 15A. “Scan setting * PDF selection” means setting in connection with a scanning operation making use of scanner portion 13 and processing for designating as PDF (Portable Document Format), a file format created by the scanning operation. The operation item may hereinafter also be referred to as an “operation item ‘PDF’.” “Scan setting * selection of M's destination” means setting in connection with a scanning operation making use of scanner portion 13, and processing for designating “M” (a specific user) registered in image processing apparatus 1 as a destination of transmission of a file created by the scanning operation.

The “operation-allowed state” refers to information specifying a condition for performing processing of an operation item associated with a gesture when a registered gesture is performed. In FIG. 3, “during preview operation” and any time are exemplified.

“During preview operation” means that a corresponding operation item is realized by a corresponding gesture only when an image obtained in image processing apparatus 1 is being previewed and an operation for designating contents of processing of the image is accepted. It is noted that, in image processing apparatus 1, preview is carried out when an image is formed by scanner portion 13 or when an image is input from other apparatuses. “Any time” means that a corresponding operation item is realized by a corresponding gesture in whichever state image processing apparatus 1 may be.

In image processing apparatus 1, control unit 50 recognizes contents of a touch operation when the touch operation is performed onto touch panel 15A. Here, recognition of contents refers, for example, to specifying a position at which the touch operation has been performed, a path of movement of the touch operation, or the like. Then, when the recognized contents match with a gesture registered in the gesture registration table, control contents the same as in the case where an operation item stored in association with the gesture is directly selected are realized. For example, in a case where a result of recognition of the touch operation is “vertical flick”, control unit 50 controls contents of display on touch panel 15A in accordance with “screen scroll” associated with the gesture of “vertical flick” in the gesture registration table.

Alternatively, in the case where a result of recognition of the touch operation is drawing of a substantially circular trail as shown in FIG. 3, control unit 50 may control image processing unit 10 in accordance with “scan setting * PDF selection” associated with a gesture for drawing the trail in the gesture registration table. Specifically, image data obtained by scanning a document may be saved in scanner portion 13 in a PDF file format.

### [Registration of Gesture]

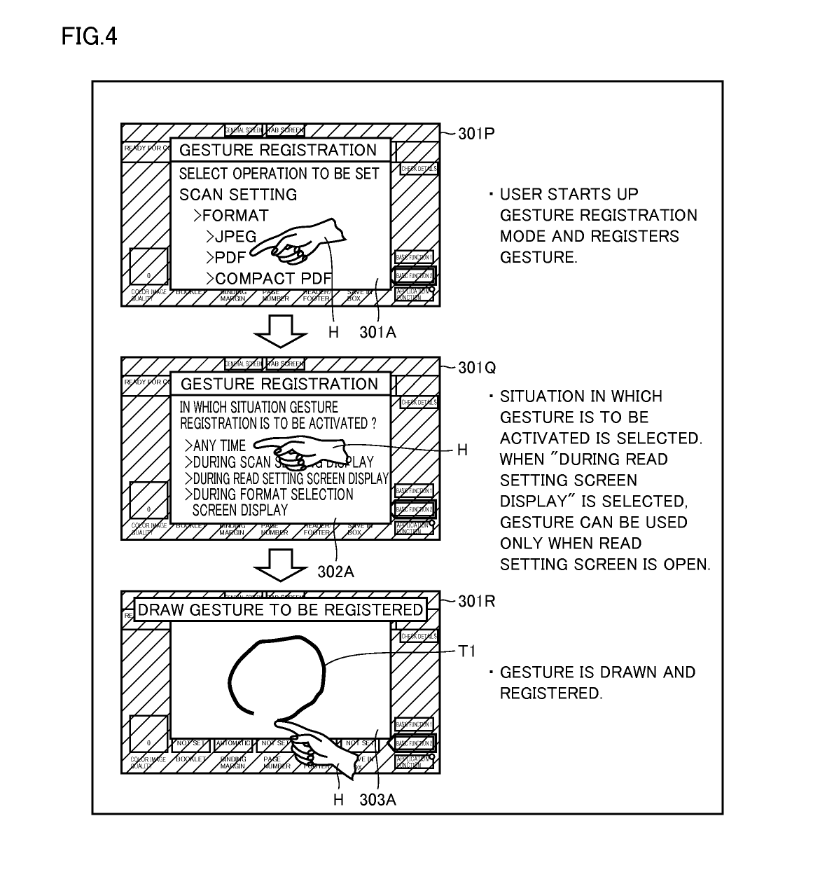

Registration of a gesture in image processing apparatus 1 will now be described. FIG. 4 is a diagram showing transition of display contents on touch panel 15A in registering a gesture.

Referring to FIG. 4, when an operation for selecting a menu for registering a gesture is performed on operation portion 15, a pop-up screen image 301A as shown in an operation screen image 301P in FIG. 4 is displayed on touch panel 15A. Pop-up screen image 301A is a screen for designating an “operation item” in the gesture registration table in FIG. 3.

Pop-up screen image 301A is displayed, for example, on operation screen image 301P displayed on touch panel 15A. When a pop-up screen is displayed, the operation screen is preferably grayed out as shown in operation screen image 301P in FIG. 4. A menu for registering a gesture is registered in image processing apparatus 1, for example, as a part of a help function.

Pop-up screen image 301A is a screen for selecting a format in which a file is saved in scan setting. Then, in pop-up screen image 301A, “JPEG (Joint Photographic Experts Group),” “PDF”, and “compact PDF” are exemplified as choices for formats. The compact PDF is such a format that an image is divided into a region of a “character” and a region of a “photograph” and the regions are subjected to compression suited for each region for conversion into PDF. Then, in operation screen image 301P in FIG. 4, a manner in which a user selects “PDF” among the formats in scan setting is shown. Thus, in the gesture registration table, “PDF” is registered as an operation item in association with a “gesture” registered in the future.

A hand H in the figure schematically shows a hand of a user who performs an operation for selecting an item displayed in pop-up screen image 301A, and it is not an item displayed in pop-up screen image 301A. In each figure that follows, hand H similarly schematically shows a hand with which a user performs an operation.

When an operation item is selected as described with reference to operation screen image 301P in FIG. 4, a pop-up screen 302A is displayed on touch panel 15A as shown in an operation screen image 301Q in FIG. 4. Pop-up screen 302A is a screen for setting an “operation-allowed state”.

In pop-up screen 302A, “any time”, “during scan setting display,” “during read setting screen display,” and “during format selection screen display” are exemplified as candidates for contents of setting of the operation-allowed state. In pop-up screen 302A, a manner in which the user selects “any time” among these is shown.

Thus, in the gesture registration table, “any time” is registered as the operation-allowed state, in association with a “gesture” registered in the future.

When an operation-allowed state is selected as described with reference to operation screen image 301Q in FIG. 4, a pop-up screen 303A is displayed on touch panel 15A as shown in an operation screen image 301R in FIG. 4. Pop-up screen 303A is a screen for inputting a gesture.

In pop-up screen 303A, a manner in which the user draws a circle as shown with a trail T1 through handwriting is shown.

Thus, in the gesture registration table, an image specified by trail T1 is registered as a “gesture”.

Through the processing for registering a series of gestures described with reference to FIG. 4 above, a “gesture”, an “operation item”, and an “operation-allowed state” designated by the user are registered in association with one another in the gesture registration table.

[Gesture Registration Processing]

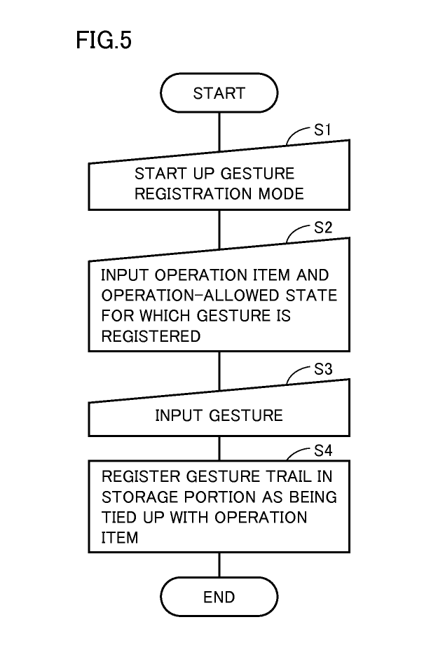

Gesture registration processing will now be described with reference to FIG. 5. FIG. 5 is a flowchart of processing performed by control unit 50 for the processing described with reference to FIG. 4.

Referring to FIG. 5, initially in step S1, control unit 50 stars up a gesture registration mode in response to a user's operation. Thus, pop-up screen image 301A as shown in operation screen image 301P is displayed on touch panel 15A.

Then, as described with reference to operation screen images 301P and 301Q in FIG. 4, in step S2, control unit 50 accepts input of an operation item and an operation-allowed state to be registered in association with a gesture to be registered in the future in the gesture registration table, and the process proceeds to step S3.

It is noted that, in step S2, control unit 50 provides display of candidates for input contents in response to user's input, as shown in pop-up screen image 301A or pop-up screen 302A. Contents of candidates to be displayed in accordance with user's input are registered, for example, in storage portion 20.

With regard to an operation item, a menu for an image processing function is registered in storage portion 20, for example, in a tree structure. Then, in accepting input of an operation item in step S2, control unit 50 provides display, for example, of menu contents registered in a next hierarchy of selected contents in a pop-up screen as candidates.

With regard to an operation-allowed state, for example, contents which can be set as an operation-allowed state are registered in storage portion 20 for each operation item. In step S2, control unit 50 reads contents which can be set for an immediately precedingly input (designated) operation item and causes the contents to be displayed in a pop-up screen as candidates for an operation-allowed state.

In step S3, control unit 50 accepts input of a gesture as described with reference to operation screen image 301R in FIG. 4, and the process proceeds to step S4.

In step S4, control unit 50 registers the operation item and the operation-allowed state of which input has been accepted in step S2 and the gesture of which input has been accepted in step S3 in association with one another in the gesture registration table, and the process ends.

[Display of Gesture]

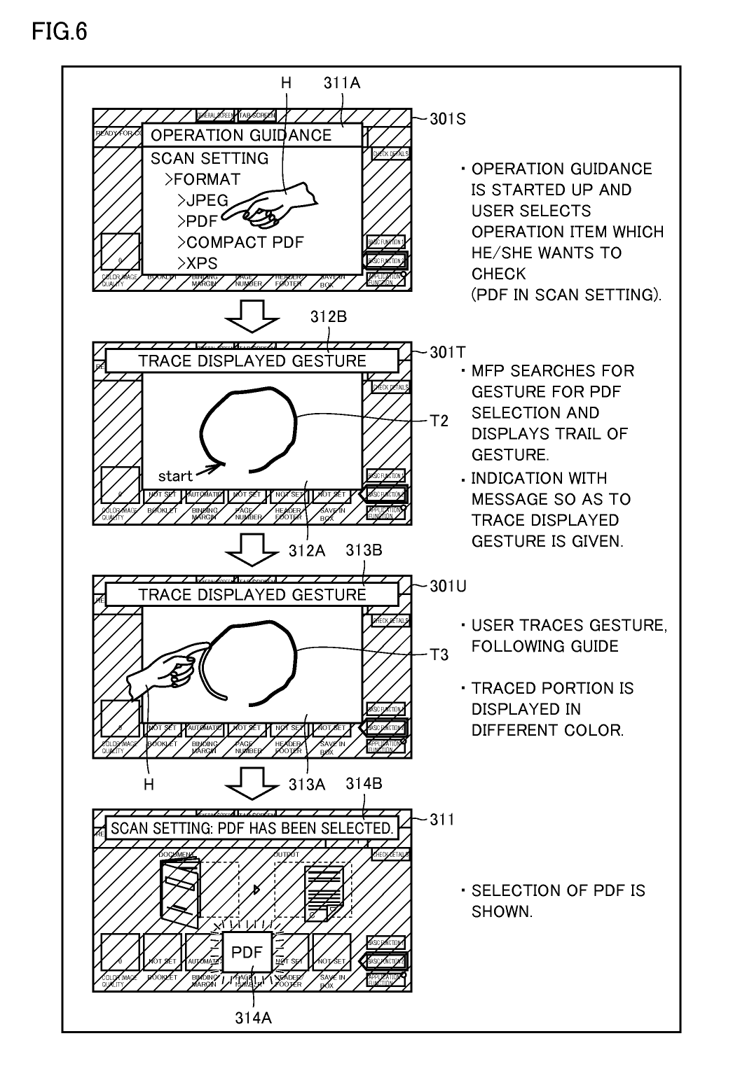

Image processing apparatus 1 has a function to have a user check contents of a gesture registered in association with a menu, for example, as one of help functions. The contents of the function will be described hereinafter with reference to FIG. 6. FIG. 6 is a diagram for illustrating display of a gesture.

Referring to FIG. 6, when an operation for starting up the help function described above is performed, in image processing apparatus 1, as shown in an operation screen image 301S, a pop-up screen 311A is displayed on touch panel 15A. Pop-up screen 311A is a screen for designating an operation item, for which checking as to whether or not a gesture has been registered in association therewith is desired. An operation screen image 301S shows a manner in which the user selects “PDF” among the formats in scan setting.

Then, when an operation item is designated, in image processing apparatus 1, a pop-up screen 312A for displaying a gesture is displayed on touch panel 15A as shown in an operation screen image 301T. In pop-up screen 312A, a substantially circular trail T2 which is a gesture registered in association with the operation item “PDF” in the gesture registration table is displayed. Trail T2 corresponds to a trail resulting from trail T1 (see FIG. 4) which has been registered in the gesture registration table and then is read.

It is noted that, in pop-up screen 312A, together with trail T2, a character string “start” indicating a starting point together with an arrow is displayed at a position serving as a starting point in drawing of trail T2. In addition, a message 312B is displayed together with pop-up screen 312A on touch panel 15A in operation screen image 301T. In message 312B, a message “trace displayed gesture” which invites reproduction of a gesture displayed in pop-up screen 312A is displayed.

The user traces trail T2 in accordance with display in pop-up screen 312A. As a result of such a user's operation, display in the pop-up screen changes.

Specifically, with change in operation position by the user, a portion of trail T2 displayed in pop-up screen 312A, over which the user finished tracing, is displayed differently from other portions. One example of such display contents is shown in an operation screen image 301U.

In operation screen image 301U, a pop-up screen 313A displayed on touch panel 15A is shown. In pop-up screen 313A, contents of display of a track T3 resulting from change in manner of display of a part of trail T2 in pop-up screen 312A are shown. Track T3 is shown, with a part of trail T2 drawn in a bold line in its entirety being hollow. Such a hollow portion indicates a portion over which the user has finished tracing. Then, when the user finishes tracing of entire trail T2 (track T3), image processing apparatus 1 causes touch panel 15A to display an operation screen at the time when an operation item corresponding to the track (gesture) is input. One example of such an operation screen (an operation screen 311) is shown in FIG. 6.

Operation screen 311 is an operation screen displayed as demonstration after display of a gesture. Thus, a most part thereof except for a button 314A and a message 314B is grayed out.

Button 314A is a software button for setting a format item in scan setting. In image processing apparatus 1, software buttons for setting various operation items are displayed on the operation screen displayed on touch panel 15A. Then, in each such software button, contents set at the current time point for a corresponding operation item are displayed. Then, operation screen 311 is an operation screen in which operation contents registered in correspondence with the operation item “PDF”, that is, “PDF” as the format item in scan setting, have been selected for button 314A as described with reference to operation screen images 301T and 301U. Namely, a character string “PDF” is displayed in button 314A.

It is noted that, in operation screen 311, as a result of the user's gesture as described with reference to operation screen images 301T and 301U, an operation item corresponding to the gesture is selected (input), and button 314A is displayed without being grayed out, in order to emphasize that display in button 314A is set to “PDF”. In addition, on operation screen 311, in order to more reliably notify the fact that the operation item above has been selected by the gesture above, a message to that effect (scan setting: PDF has been selected”) is displayed in message 314B. The message includes a character string specifying the selected operation item (“scan setting: PDF”). Thus, the user can more reliably be caused to recognize to which operation item the gesture corresponds as a result of the user's gesture.

[Display in a Case where User has Failed in Reproduction]

In the processing described with reference to FIG. 6, the gesture (trail T2) displayed in pop-up screen 312A (operation screen image 301T) is successfully reproduced by the user, so that a screen at the time when operation contents registered in association with the gesture are selected is displayed on touch panel 15A (operation screen 311).

It is noted that, when the user did not successfully reproduce the displayed gesture, image processing apparatus 1 provides display as such and an indication inviting reproduction of the gesture is given until reproduction is successful.

Specifically, for example, with respect to trail T2 in pop-up screen 312A in operation screen image 301T, when a trail traced by the user is significantly displaced from trail T2 like a trail L1 within a pop-up screen 315A in an operation screen image 301W, a pop-up screen 316A and a message 316B are displayed on touch panel 15A as shown in an operation screen image 301X. Pop-up screen 316A is a screen displaying trail T2 together with such a character string as “start”, similarly to pop-up screen 312A. Message 316B includes a message “Gesture cannot be recognized. Please trace again.” which corresponds to notification that the user's gesture cannot be identified as the gesture corresponding to trail T2 and a message inviting trace (reproduction) of trail T2 again, as described with reference to operation screen image 301W.

[Display in a Case where Associated Gesture has not been Registered]

Even though an operation item is input as described with reference to operation screen image 301S in FIG. 6, in the case where a gesture corresponding to the operation item has not been registered in the gesture registration table, another operation method for selecting an operation item is displayed on touch panel 15A, instead of display of the gesture.

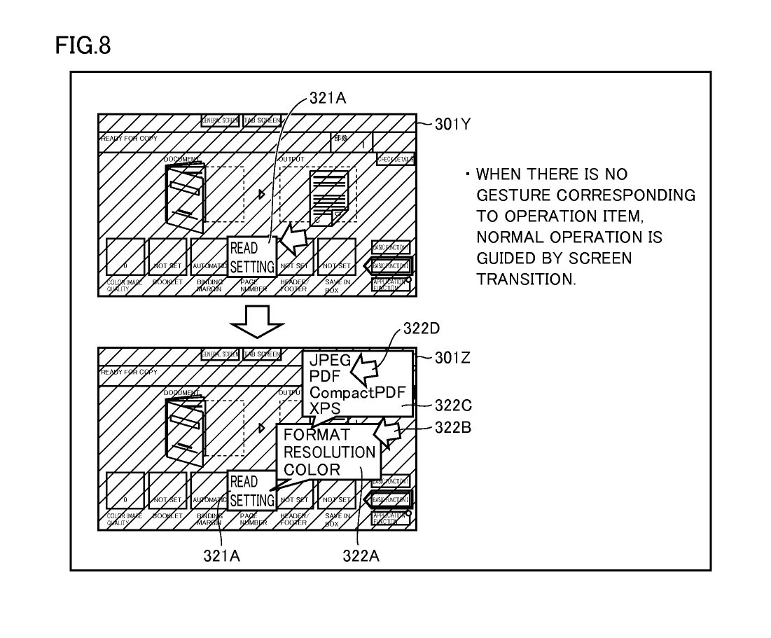

Namely, when the operation item “PDF” is selected as described with reference to operation screen image 301S and when a gesture corresponding to the operation item has not been registered in the gesture registration table, operation screen image 301 is displayed on touch panel 15A, with components other than a button 321A for inputting scan setting being grayed out, as shown in an operation screen image 301Y in FIG. 8.

Then, in addition, as shown in an operation screen image 301Z in FIG. 8, a pop-up screen 322A for displaying a generic item for scan setting is displayed on touch panel 15A. In pop-up screen 322A, in order to input the operation item “PDF”, an auxiliary image 322B indicating an item to be selected from among three generic items of “format”, “resolution”, and “color” displayed in pop-up screen 322A is displayed.

In operation screen image 301Z, auxiliary image 322B indicates “format” among the three generic items. Then, in addition, a pop-up screen 322C is displayed on touch panel 15A. Pop-up screen 322C is a screen displayed at the time when the generic item “format” is selected. In pop-up screen 322C, four specific items “JPEG”, “PDF”, “Compact PDF”, and “XPS” for scan setting are displayed. In addition, in pop-up screen 322C, in order to select an operation item “PDF”, an auxiliary image 322D for indicating an item to be selected from among the specific items displayed in pop-up screen 322C is displayed. It is noted that, in operation screen image 301Z, auxiliary image 322D indicates “PDF” among the four specific items above.

[Gesture Display Processing]

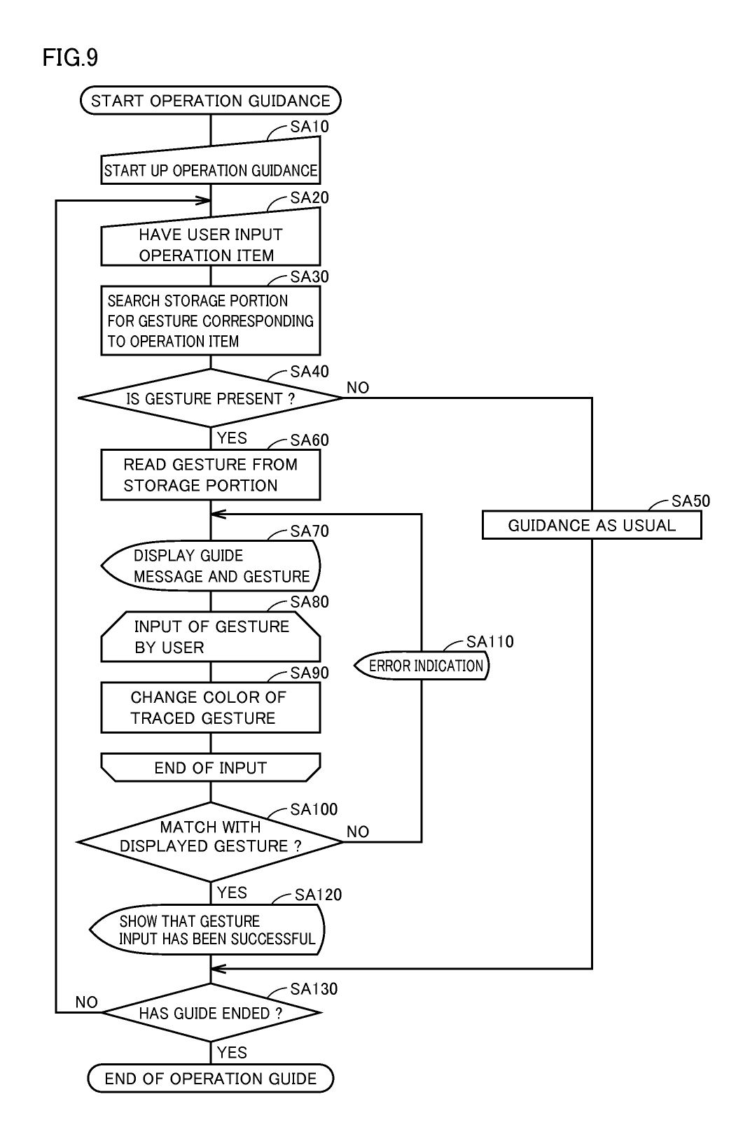

Gesture display processing will now be described. FIG. 9 is a flowchart of processing (gesture display processing) performed by control unit 50 for implementing the processing described with reference to FIGS. 6 to 8.

When an operation for starting up the help function above (a function for checking contents of the gesture) is performed on operation portion 15, in step SA10, control unit 50 starts up an operation guidance application, and the process proceeds to step SA20.

In step SA20, control unit 50 accepts user's input of an operation item as described with reference to operation screen image 301S in FIG. 6, and the process proceeds to step SA30.

In step SA30, control unit 50 searches the gesture registration table for a gesture stored in association with the operation item of which input has been accepted in step SA20, and the process proceeds to step SA40.

In step SA40, control unit 50 determines whether or not the gesture registered in the gesture registration table could be obtained as a search result through the processing in step SA30. When it is determined that the gesture could be obtained, the process proceeds to step SA60, and when it is determined that the gesture could not be obtained (that is, there was no gesture registered in association with the operation item above in the gesture registration table), the process proceeds to step SA50.

In step SA50, control unit 50 provides guidance other than display of the gesture as described with reference to FIG. 8, and the process proceeds to step SA130.

On the other hand, in step SA60, control unit 50 reads the gesture registered in association with the input operation item in the gesture registration table, and the process proceeds to step SA70.

In step SA70, control unit 50 causes touch panel 15A to display a guide message (a message) and a gesture as described with reference to operation screen image 301T in FIG. 6, and the process proceeds to step SA80.

In step SA80, control unit 50 accepts user's input as described with reference to operation screen image 301U in FIG. 6, and the process proceeds to step SA90.

In step SA90, control unit 50 changes a manner of display of a portion of trail T2 over which the user has finished tracing as shown with track T3 in operation screen image 301U.

Then, control unit 50 determines in step SA100 whether or not a location where the user's input has been provided matches with a position of display of trail T2 in parallel to the processing in step SA80 and step SA90. This determination is made, for example, by determining whether or not a position at which the user has touched touch panel 15A is distant from trail T2 by a specific distance or more. Then, on condition that the user's touch position has moved to an end point of trail T2 (an end opposite to an end denoted as “start”) or to a position distant from the end point by a distance shorter than the specific distance above without determination as not matching, the process proceeds to step SA120.

It is noted that, when the user's touch position is distant from trail T2 by the specific distance or more before it moves to the end point of trail T2 or to the position distant from the end point by a distance shorter than the specific distance above, the process proceeds from step SA100 to step SA110.

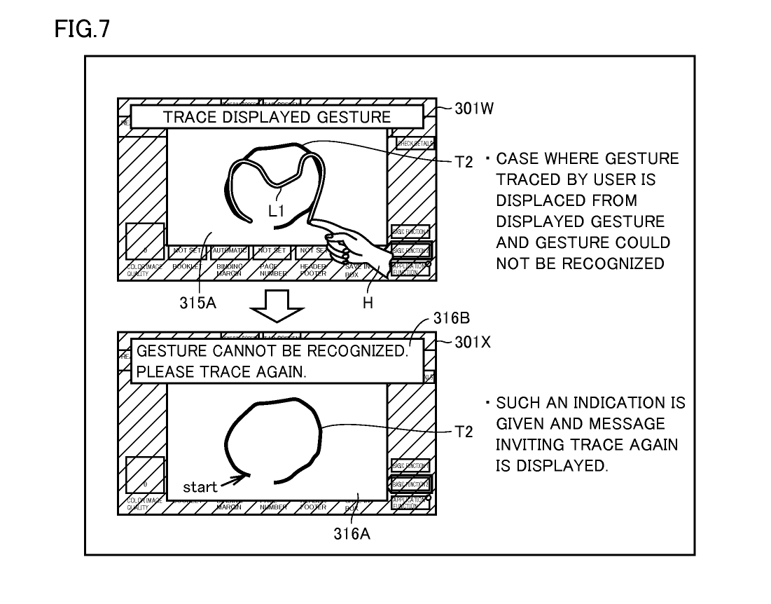

In step SA110, control unit 50 provides such an error indication as inviting redo of reproduction of trail T2 as described with reference to operation screen image 301X in FIG. 7, and the process returns to step SA70.

In step SA120, control unit 50 causes touch panel 15A to display success of input of the gesture as described with reference to operation screen 311, and the process proceeds to step SA130.

In step SA130, control unit 50 determines whether or not guide may end. For example, when the user has input to operation portion 15, a matter for which he/she additionally desires guide, control unit 50 causes the process to return to step SA20, determining that guide should not end. On the other hand, when the user has provided input indicating end of guide to operation portion 15, control unit 50 causes the process to end, determining that guide may end.

In step SA100 in the gesture display processing described above, when input for reproduction of the gesture is provided by the user, positional relation between the touch position on touch panel 15A and trail T2 is sequentially compared, and when a position distant from trail T2 by a specific distance or more was touched, an error indication was immediately provided in step SA110.

It is noted that the error indication may be provided after the end point of trail T2 (or the position within a specific distance from the end point) is touched. Namely, control unit 50 may allow the process to proceed to step SA100 on condition that the user's touch position has reached the end point of trail T2 (or the position within the specific distance from the end point). In step SA100, control unit 50 determines whether or not a trail of the touch position from start of acceptance of the user's input in step SA80 until then includes a position distant from trail T2 by a specific distance or more. Then, when control unit 50 determines that the trail includes that position, the process proceeds to step SA110, and when it determines that the trail does not include that position, the process proceeds to step SA120.

[Variation (1) of Gesture Display]

Display of a gesture in image processing apparatus 1 may be provided as a motion picture. In this case, information specifying a motion picture of a gesture is registered in the gesture registration table (FIG. 3).

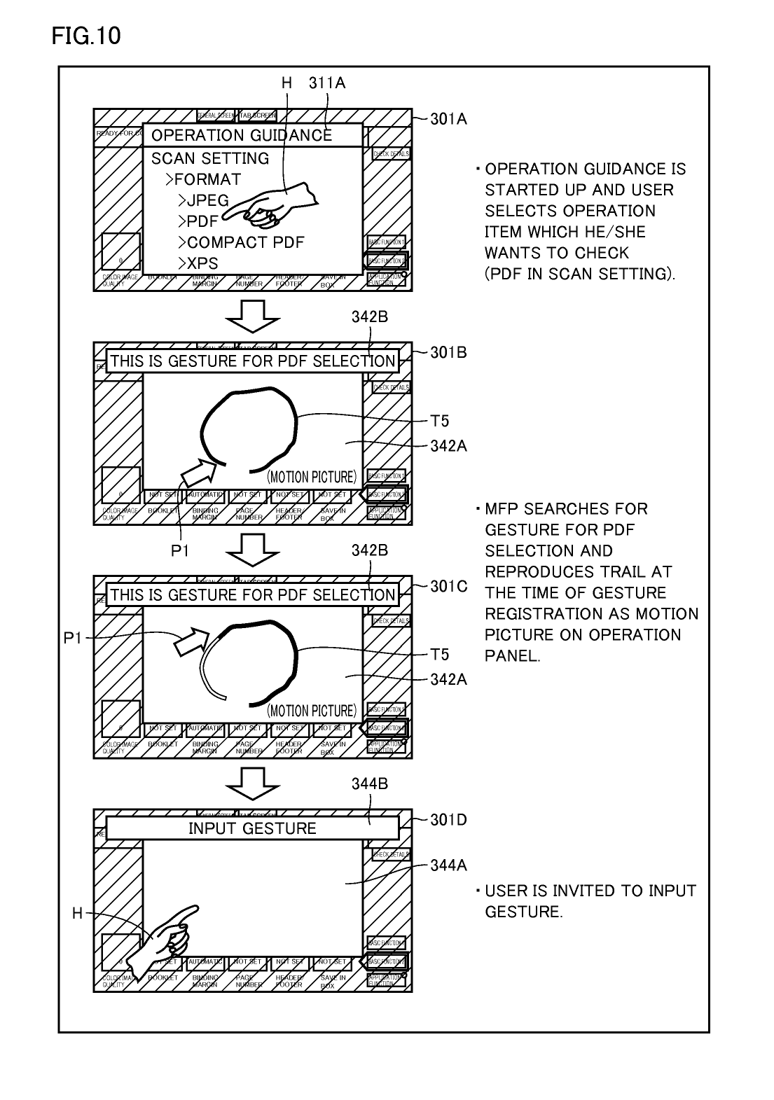

Display of a gesture in variation (1) will be described with reference to FIG. 10. An operation screen image 301A in FIG. 10 shows a manner in which an operation item is input on touch panel 15A as in operation screen image 301P in FIG. 6 after the help function is started up in variation (1). In variation (1), when an operation item is input as such, a pop-up screen 342A is displayed as shown in an operation screen image 301B in FIG. 10.

In pop-up screen 342A, initially, a trail of a track of a registered gesture is displayed as a trail T5. Thereafter, in pop-up screen 342A, a pointer P1 is displayed in the vicinity of the starting point of the track.

It is noted that a message 342B is displayed together with pop-up screen 342A on touch panel 15A. Message 342B is a character string “this is gesture for PDF selection,” and it is a message notifying that trail T5 displayed in pop-up screen 342A is a gesture stored in association with an operation item selected as shown in operation screen image 301A (that is, a gesture like a shortcut for selecting the operation item).

Then, pointer P1 moves over trail T5, following the track. The trail over which pointer P1 on trail T5 has moved is displayed differently from other portions on trail T5, as shown in an operation screen 301C in FIG. 10. Namely, in variation (1), trail T5 is displayed as a motion picture in such a manner that drawing of trail T5 is completed over time.

As pointer P1 has moved to the end point of trail T5, a pop-up screen 344A and a message 344B are displayed on touch panel 15A as shown in an operation screen 301D in FIG. 10.

Pop-up screen 344A is a screen for accepting a user's touch operation. Message 344B (“input gesture”) is a message inviting input in pop-up screen 344A, of a gesture the same as the gesture shown with trail T5.

Image processing apparatus 1 compares the trail of the touch operation onto pop-up screen 344A with trail T5. Then, when the trail of the touch operation reaches the end point of trail T5 (or a point within a specific distance from the end point) without being distant from trail T5 by a specific distance or more, an operation screen at the time when the operation item above is selected is displayed on touch panel 15A as shown in operation screen 311 in FIG. 6. When the trail of the touch operation is distant from trail T5 by a specific distance or more before it reaches the end point of trail T5 (or the point within the specific distance from the end point), as described with reference to operation screen image 301X in FIG. 7, an error indication and a message inviting input of trail T5 again are displayed on touch panel 15A.

It is noted that, in order to assist input of trail T5, in pop-up screen 344A (operation screen image 301D in FIG. 10), trail T5 may be displayed in a color lighter than the color displayed, for example, in operation screen image 301B in FIG. 10.

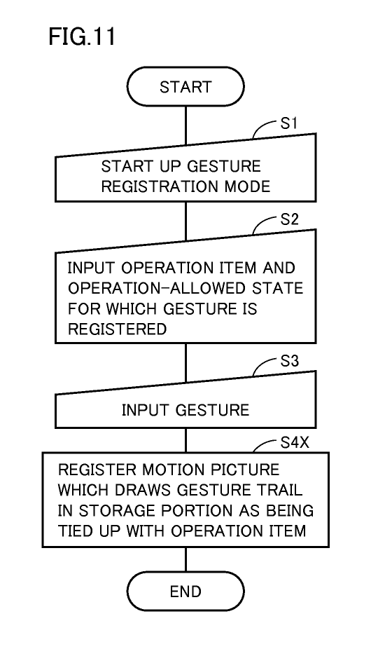

Gesture registration processing in variation (1) will now be described. FIG. 11 is a flowchart of a variation of the gesture registration processing (FIG. 5) in accordance with variation (1).

A trail of a touch position is registered as a gesture in step S4 in FIG. 5, however, in the flowchart in FIG. 11, information specifying a motion picture is registered as a gesture in step S4X.

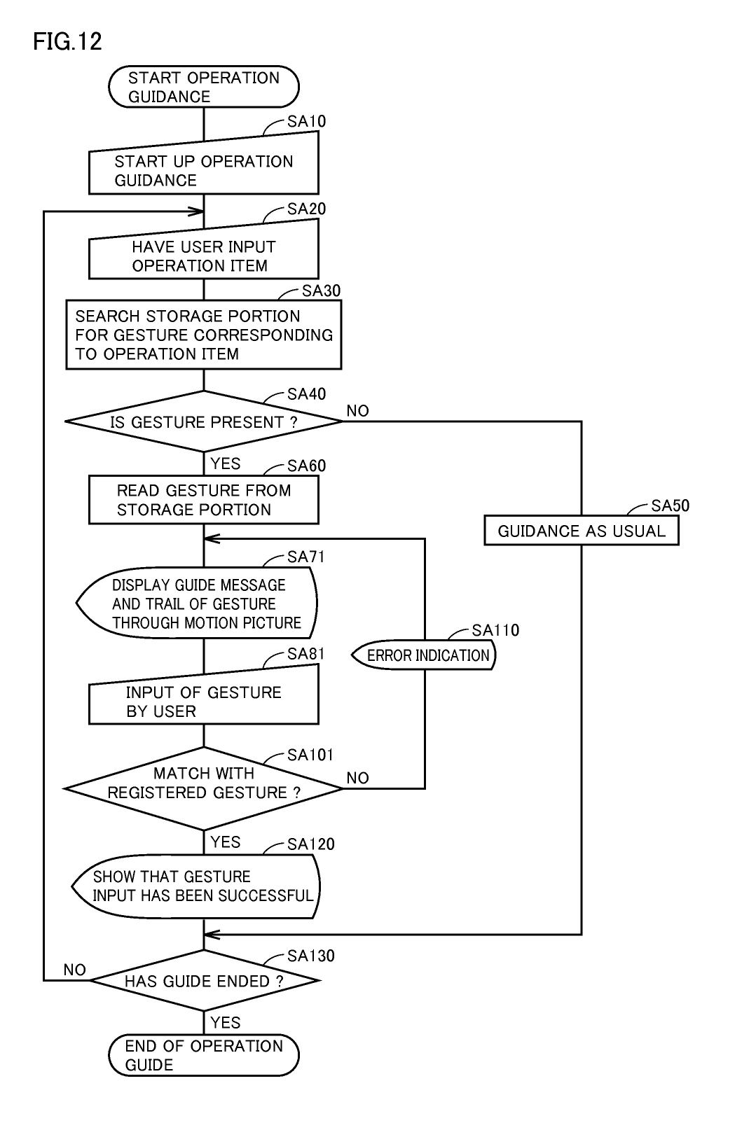

Gesture display processing in variation (1) will now be described. FIG. 12 is a flowchart of a variation in accordance with variation (1) of the gesture display processing (FIG. 9).

A trail (trail T2 in operation screen image 301T in FIG. 6) is displayed as a gesture together with a guide message in step SA70 in FIG. 9, however, in the flowchart in FIG. 12, a motion picture (operation screen image 301C in FIG. 10) is displayed as a gesture together with a guide message in step SA71.

In addition, whether or not a touch operation input in parallel to acceptance of user's input matches with a registered gesture is determined in step SA100 in FIG. 9, however, in the flowchart in FIG. 12, whether or not a touch operation input after the user's input is completed matches with a registered gesture is determined in step SA101.

[Variation (2) of Gesture Display]

A variation of gesture display will be described. In variation (2), in image processing apparatus 1, a speed in connection with a gesture is registered in association with an operation item.

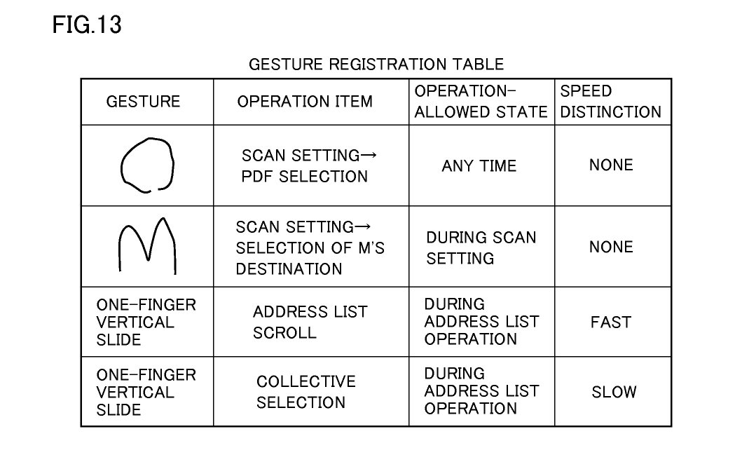

Contents in a gesture registration table in variation (2) will be described. FIG. 13 is a diagram schematically showing one example of contents in a gesture registration table in variation (2).

Referring to FIG. 13, in the gesture registration table in variation (2), as compared with the table shown in FIG. 3, “speed distinction” is added as an item registered in association with each gesture. The table in FIG. 13 includes a gesture “one-finger vertical slide” registered in association with speed distinction “fast” and a gesture “one-finger vertical slide” registered in association with speed distinction “slow”.

A gesture associated with speed distinction “fast” and a gesture associated with speed distinction “slow” are associated with operation items different from each other. Specifically, the former is associated with an operation item “address list scroll” and the latter is associated with an operation item “collective selection”.

<Registration of Gesture>

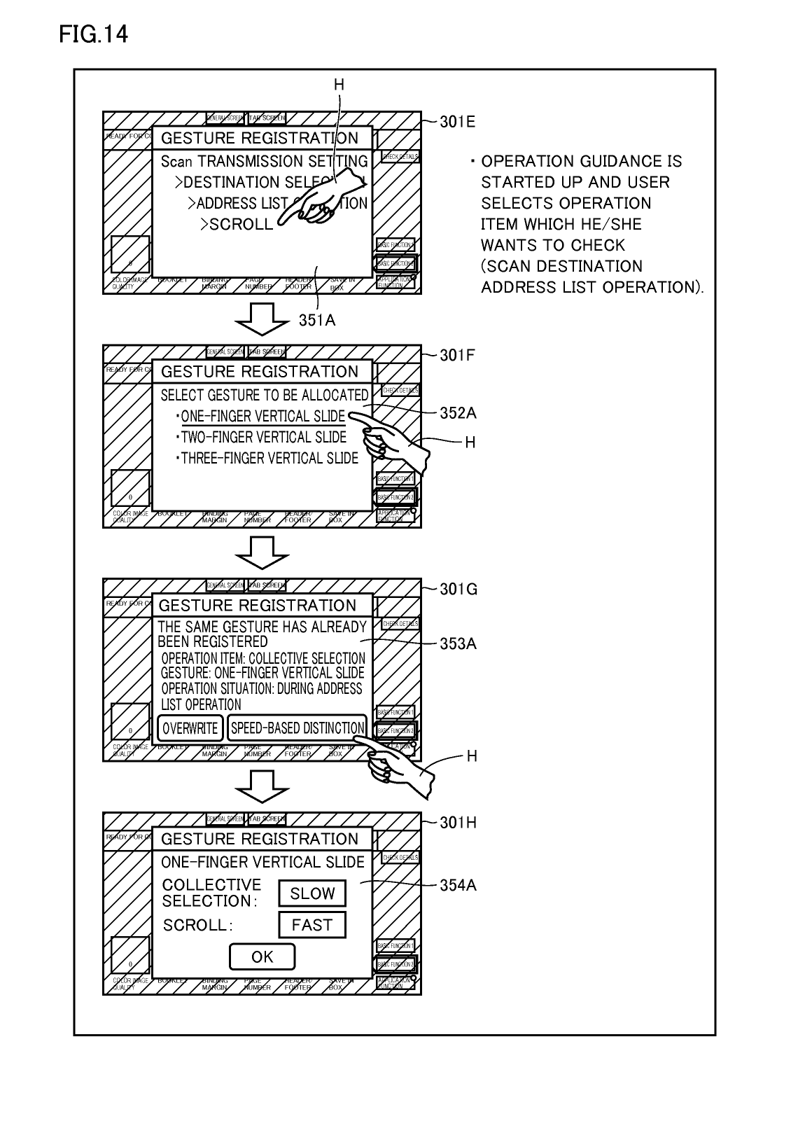

A variation of gesture registration will now be described. FIG. 14 is a diagram for illustrating registration of a gesture in variation (2).

In image processing apparatus 1 shown in FIG. 14, the user designates an “operation item” in a pop-up screen 351A in an operation screen image 301E in FIG. 14, similarly to designation of an “operation item” in pop-up screen image 301A in operation screen image 301P in FIG. 4.

Then, in image processing apparatus 1, the user registers a gesture as described with reference to operation screen image 301R in FIG. 4, after designation of an “operation-allowed state” to be associated with the operation item above as described with reference to operation screen image 301Q in FIG. 4. In variation (2), an example where a gesture from among those registered in advance in image processing apparatus 1 (storage portion 20) is registered is shown. Specifically, description will be given with reference to an operation screen image 301F in FIG. 14.

A pop-up screen 352A displayed on touch panel 15A is shown in operation screen image 301F. In pop-up screen 352A, three items of “one-finger vertical slide,” “two-finger vertical slide,” and “three-finger vertical slide” are shown as candidates for gestures to be registered. An example where “one-finger vertical slide” is selected is shown in operation screen image 301F.

Here, it is assumed that the gesture “one-finger vertical slide” has already been registered in association with another operation item in the gesture registration table. In this case, in image processing apparatus 1, registration of such a gesture may be prohibited and selection of another gesture may be accepted. Alternatively, in pop-up screen 352A, a gesture other than the gesture already associated with another operation item may be displayed as a candidate. Alternatively, a screen for distinction from already registered other operation items based on a speed of input of a gesture may be displayed. A pop-up screen 353A in an operation screen image 301G in FIG. 14 is a screen displayed in variation (2) in a case where the gesture selected in pop-up screen 352A has already been associated with another operation item.

In pop-up screen 353A, together with a message that the gesture selected in pop-up screen 352A has already been associated with another operation item in the gesture registration table, another operation item, the selected gesture, and the selected operation-allowed state are displayed. In pop-up screen 353A, the message above is a character string “the same gesture has already been registered.” Another operation item is “collective selection”. The selected gesture is “one-finger vertical slide.” The selected operation-allowed state is “during address list operation.”

In pop-up screen 353A, two buttons for input of contents selected by the user are further displayed. One is an “overwrite button” and the other is a “speed-based distinction button.” The “overwrite button” is a button for registering the selected gesture in association with the currently selected operation item, in place of the already registered operation item. Thus, the already registered operation item is erased from the gesture registration table. The “speed-based distinction button” is a button for registering the selected gesture, with the already registered operation item and the currently selected operation item being distinguished from each other based on a speed. Here, contents of processing at the time when the “speed-based distinction button” is operated will be described.

When the “speed-based distinction button” is operated, a pop-up screen 354A is displayed on touch panel 15A as shown in an operation screen image 301H in FIG. 14.

Pop-up screen 354A is a screen for setting a speed of input of a selected gesture, for each of the already registered operation item and the currently selected operation item. A speed of input set in accordance with such a screen is the speed (fast, slow) written in the field of “speed distinction” in FIG. 13.

<Display of Gesture>

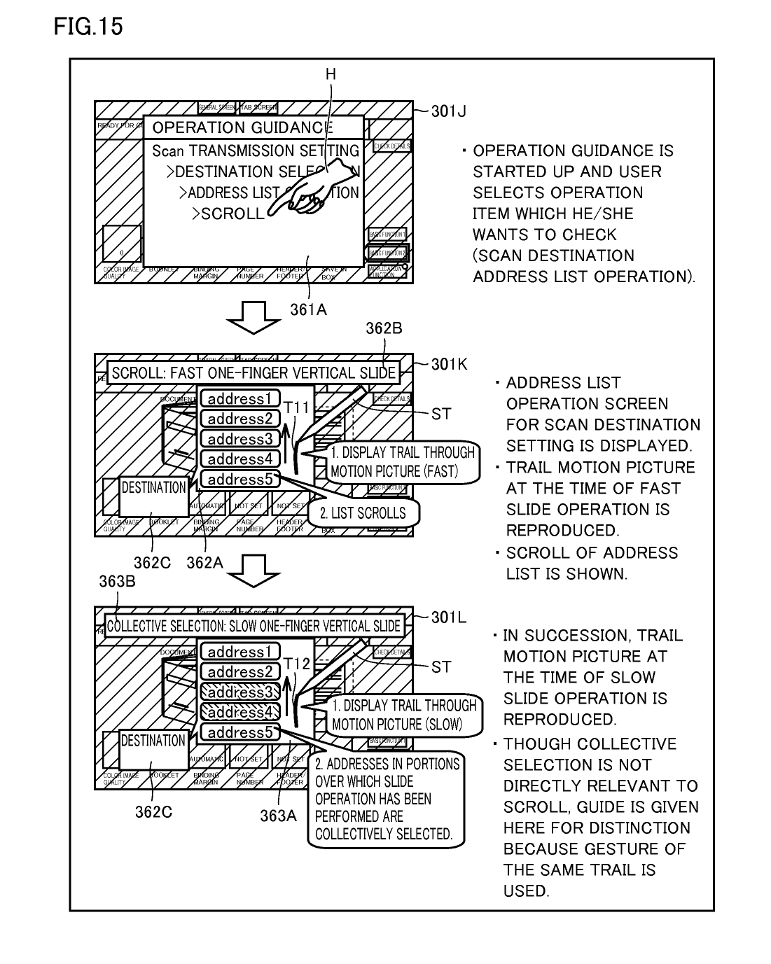

FIG. 15 is a diagram for illustrating display of a gesture in variation (2).

Referring to FIG. 15, in image processing apparatus 1, as described with reference to operation screen image 301S in FIG. 6, designation of an operation item is accepted as shown in an operation screen image 301J in FIG. 15. Specifically, the user designates an operation item for displaying a gesture in a pop-up screen 361A in operation screen image 301J.

In response, as shown in an operation screen image 301K in FIG. 15, a pop-up screen 362A and a message 362B are displayed on touch panel 15A. Pop-up screen 362A is a screen for displaying a gesture corresponding to the designated operation item. Message 362B is a message explaining contents of the gesture displayed in pop-up screen 362A.

In operation screen image 301K, the message above is “scroll: fast one-finger vertical slide.” “Scroll” is a character string indicating the designated operation item. “Fast one-finger vertical slide” is a character string indicating contents of the gesture, specifically a speed (fast) and a type (one-finger vertical slide) of the gesture.

In addition, on touch panel 15A in operation screen image 301K, together with pop-up screen 362A, an image ST of a stylus pen for explaining contents of the gesture in detail and a trail T11 drawn by the gesture are displayed. Here, a motion picture in which trail T11 is drawn by relatively fast movement of image ST is displayed. Two balloons in operation screen image 301K are explanation of this motion picture, and they are not actually displayed on touch panel 15A. Then, in pop-up screen 362A, scroll display of a list of addresses being displayed (“address 1”, “address 2”, “address 3”, . . . ) is provided as an effect of drawing of trail T11 by image ST. An arrow in pop-up screen 362A indicates a direction of scroll (an upward direction) of the list.

In addition, in operation screen image 301K, a button 362C is displayed without being grayed out, which means that contents displayed in pop-up screen 362A are setting contents corresponding to button 362C (destination (selection of destination)).

For example, as described with reference to operation screen image 301U, when the user completes input in accordance with the gesture shown in operation screen image 301K, display on touch panel 15A changes to display shown in an operation screen image 301L in FIG. 15.

In operation screen image 301L, a pop-up screen 363A and a message 363B are displayed on touch panel 15A. Pop-up screen 363A is a screen for displaying a gesture of an operation item associated with the gesture the same as that of the operation item selected in operation screen image 301J. Message 363B is a message explaining contents of the gesture displayed in pop-up screen 363A.

In operation screen image 301L, the message above is “collective selection: slow one-finger vertical slide.” “Collective selection” is a character string indicating operation items to be displayed in pop-up screen 363A. “Slow one-finger vertical slide” is a character string indicating contents of the gesture displayed in pop-up screen 363A, specifically a speed (slow) and a type (one-finger vertical slide) of the gesture.

In addition, on touch panel 15A in operation screen image 301L, together with pop-up screen 363A, image ST of the stylus pen for explaining contents of the gesture in detail and a trail T12 drawn by the gesture are displayed. Here, a motion picture in which trail T12 is drawn by relatively slow movement of image ST is displayed. Two balloons in operation screen image 301L are explanation of this motion picture, and they are not actually displayed on touch panel 15A. Then, in pop-up screen 363A, such a state that addresses overlapping with trail T12 in a vertical direction (“address 3” and “address 4”) in a list of addresses being displayed (“address 1”, “address 2”, “address 3”, “address 4”, and “address 5”) are selected (a state of highlighted display) is shown as an effect of drawing of trail T12 by image ST. An arrow in pop-up screen 363A indicates a direction in which newly selected address is located when image ST moves from below to above.

In addition, in operation screen image 301L, button 362C is displayed without being grayed out, which means that contents displayed in pop-up screen 363A are setting contents corresponding to button 362C (destination (selection of a destination)).

<Gesture Registration Processing>

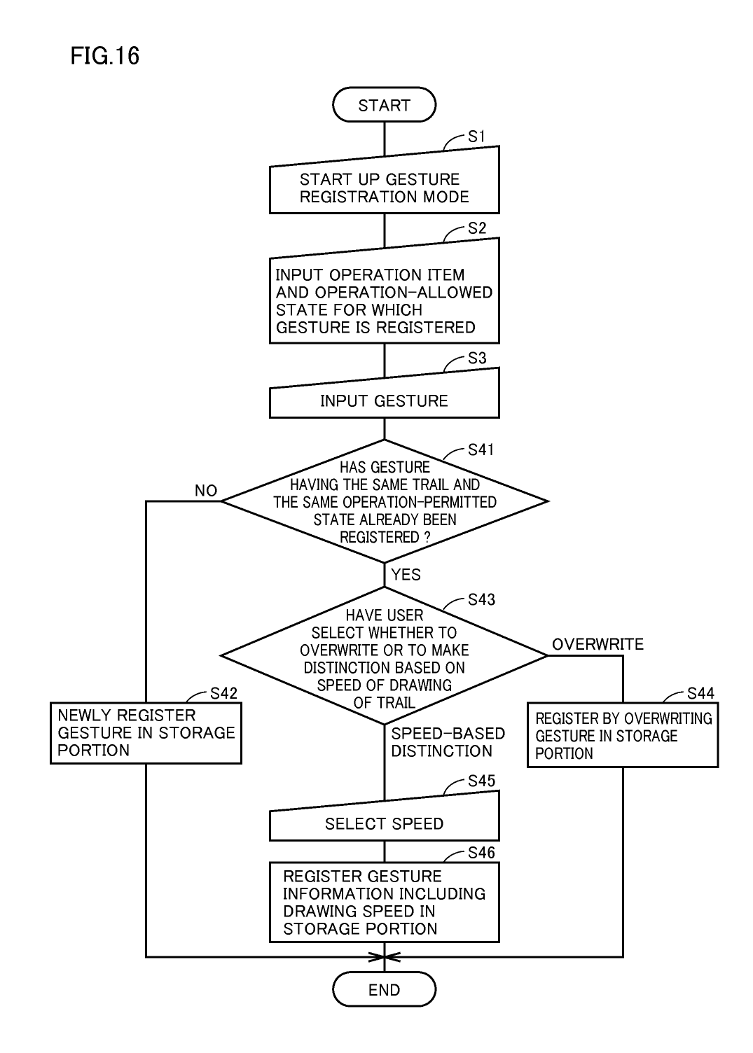

A variation of the gesture registration processing will be described. FIG. 16 is a flowchart of gesture registration processing performed in variation (2).

Referring to FIG. 16, in the gesture registration processing in variation (2), as compared with the gesture registration processing in FIG. 5, steps S41 to step S46 are performed instead of step S4 in FIG. 5.

Specifically, in variation (2), when a gesture is input in step S3, control unit 50 causes the process to proceed to step S41.

In step S41, control unit 50 determines whether or not an operation item competing with the gesture input in step S3 has been registered in the gesture registration table. When it is determined that the competing operation item has been registered, the process proceeds to step S43, and when it is determined that the competing operation item has not been registered, the process proceeds to step S42.

It is noted that, in step S41, for example, control unit 50 determines whether or not there is an operation item registered in association with an operation-permitted state overlapping with at least a part of the operation-allowed state input in step S2, which is the track the same as the gesture input in step S3 (the gesture identical in contents). When it is determined that there is no such an operation item, the process proceeds to step S42, and when it is determined that there is such an operation item, the process proceeds to step S43.

In step S42, control unit 50 registers a gesture or the like in the gesture registration table in accordance with the designated contents as in step S4 in FIG. 5, and the process ends.

On the other hand, in step S43, control unit 50 accepts from the user, designation as to whether to register by overwriting a gesture or to register the same gesture for both of operation items with distinction from each other based on a speed of operation, as described with reference to operation screen image 301G in FIG. 14. Then, when the contents of the designation indicate overwrite, control unit 50 causes the process to proceed to step S44, and when the contents indicate distinction based on a speed, control unit 50 causes the process to proceed to step S45.

In step S44, control unit 50 erases registered contents as to the “competing” operation item above which has already been registered in the gesture registration table, and registers in that table, the contents of which input has been accepted in step S2 and step S3 in the present gesture registration processing. Then, the process ends.

On the other hand, in step S45, control unit 50 accepts selection of a speed of movement of an operation for each competing operation item as described with reference to operation screen image 301H in FIG. 14, and the process proceeds to step S46.

In step S46, control unit 50 registers a gesture or the like including also a speed of operation, for each competing operation item as described with reference to FIG. 13, and the process ends.

<Gesture Display Processing>

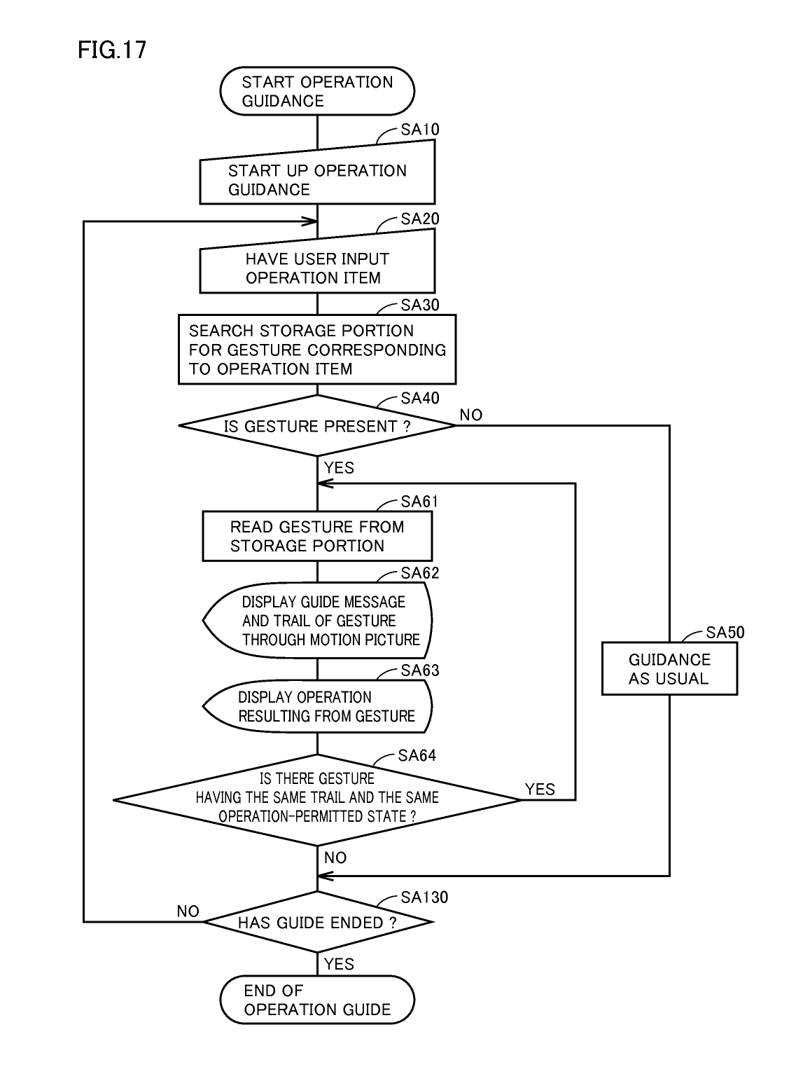

A variation of the gesture display processing will be described. FIG. 17 is a flowchart of gesture display processing performed in variation (2).

Referring to FIG. 17, in the gesture display processing in variation (2), control unit 50 performs step SA10 to step SA40 as in the gesture display processing in FIG. 9. Then, when it is determined in step SA40 that the gesture registered in the gesture registration table could be obtained as a search result in the processing in step SA30, the process proceeds to step SA61.

In step SA61, control unit 50 reads the gesture obtained as the search result from the gesture registration table, and the process proceeds to step SA62.

In step SA62, control unit 50 causes touch panel 15A to display a motion picture of the gesture read in step SA61 and a guide message corresponding to the gesture as described with reference to operation screen image 301K in FIG. 15, and the process proceeds to step SA63.

It is noted that, in step SA 62, control unit 50 may invite further input of the gesture, and the process may proceed to step SA63 on condition that input corresponding to the gesture has been provided.

In step SA63, control unit 50 provides display resulting from the gesture performed on touch panel 15A (an effect of the gesture), like scroll display in pop-up screen 362A or display of button 362C described in connection with operation screen image 301K in FIG. 15, and the process proceeds to step SA64.

In step SA64, control unit 50 determines whether or not there is a gesture which is the same as the gesture in display provided in immediately preceding step SA61 to step SA63 and which has not yet been set as an object of display in step SA61 to step SA63 in present gesture display processing, among gestures registered in the gesture registration table. When control unit 50 determines that there is such a gesture, control unit 50 provides display of that gesture in step SA61 to step SA63. Namely, after the display described with reference to operation screen image 301K in FIG. 15, display described with reference to operation screen image 301L in FIG. 15 is further provided. Thereafter, the process proceeds to step SA130.

In step SA130, control unit 50 determines whether or not guide may end as in step SA130 in FIG. 9. Then, when control unit 50 determines that guide should not end, the process returns to step SA20, and when it determines that guide may end, the process ends.

[Variation (3)]

In a variation (3), in the gesture display processing, in addition to the gesture associated with the designated operation item, a gesture for an operation for enlarging a region where the gesture is performed is displayed.

<Display of Gesture>

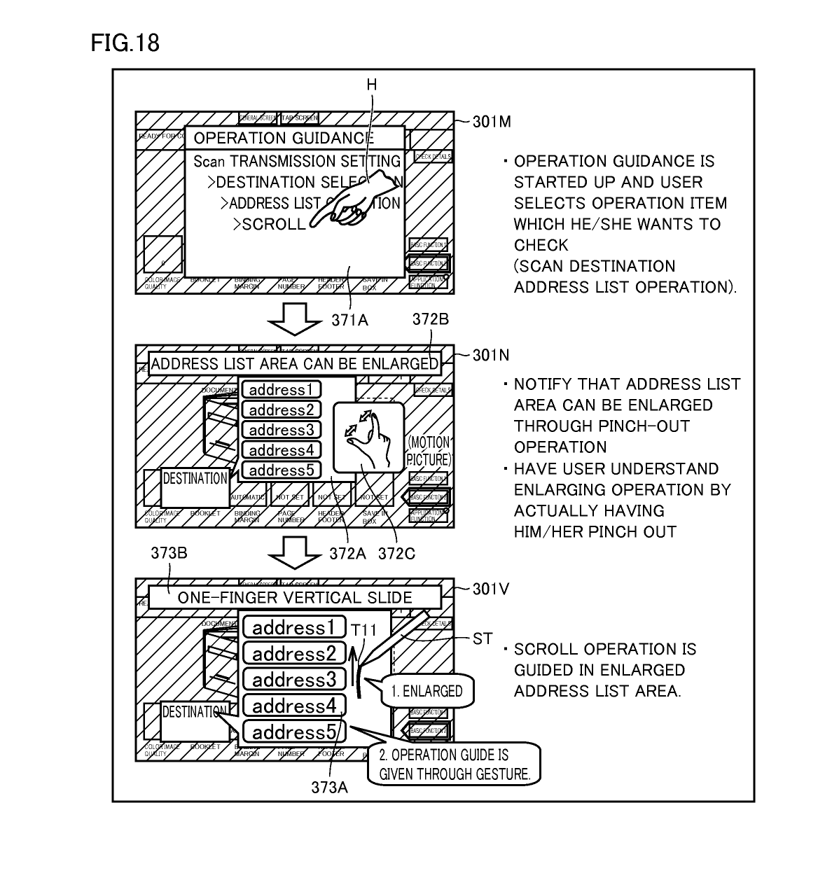

A variation of gesture display will be described. FIG. 18 is a diagram for illustrating display of a gesture in variation (3).

As shown in an operation screen image 301M, when an operation item is designated in a pop-up screen 371A, whether or not a size of a region for input of a gesture corresponding to the operation item is equal to or smaller than a specific area is determined. Information specifying the “specific area” defined as a threshold value here is registered in advance, for example, in storage portion 20. It is noted that the registered contents may be updated as appropriate by the user.

Then, when it is determined that the size is equal to or smaller than the specific area, a pop-up screen 372C and a message 372B are displayed together with pop-up screen 372A corresponding to the designated operation item on touch panel 15A, as shown in an operation screen image 301N. Pop-up screen 372C is a screen for displaying a gesture corresponding to operation contents for enlarging a display area of pop-up screen 372A. Message 372B is a message for explaining the gesture displayed in pop-up screen 372C. The message is that an address list area (corresponding to a pop-up screen 372A) can be enlarged.

In pop-up screen 372C, a motion picture of such movement that a distance between positions within pop-up screen 372A touched by two fingers is made greater is displayed.

Here, a case where the user provides input in accordance with the gesture on touch panel 15A, in accordance with display in pop-up screen 372C, will be described. In this case, display in pop-up screen 372A in operation screen image 301N is enlarged as shown as a pop-up screen 373A in an operation screen image 301V. Then, in pop-up screen 373A, as described with reference to operation screen image 301K in FIG. 15, such a motion picture that image ST is displayed as moving and trail T11 is correspondingly drawn is displayed, so that the gesture is displayed as a motion picture.

In addition, on touch panel 15A in operation screen image 301V, contents of the gesture (one-finger vertical slide) are displayed as a message 373B.

<Gesture Display Processing>

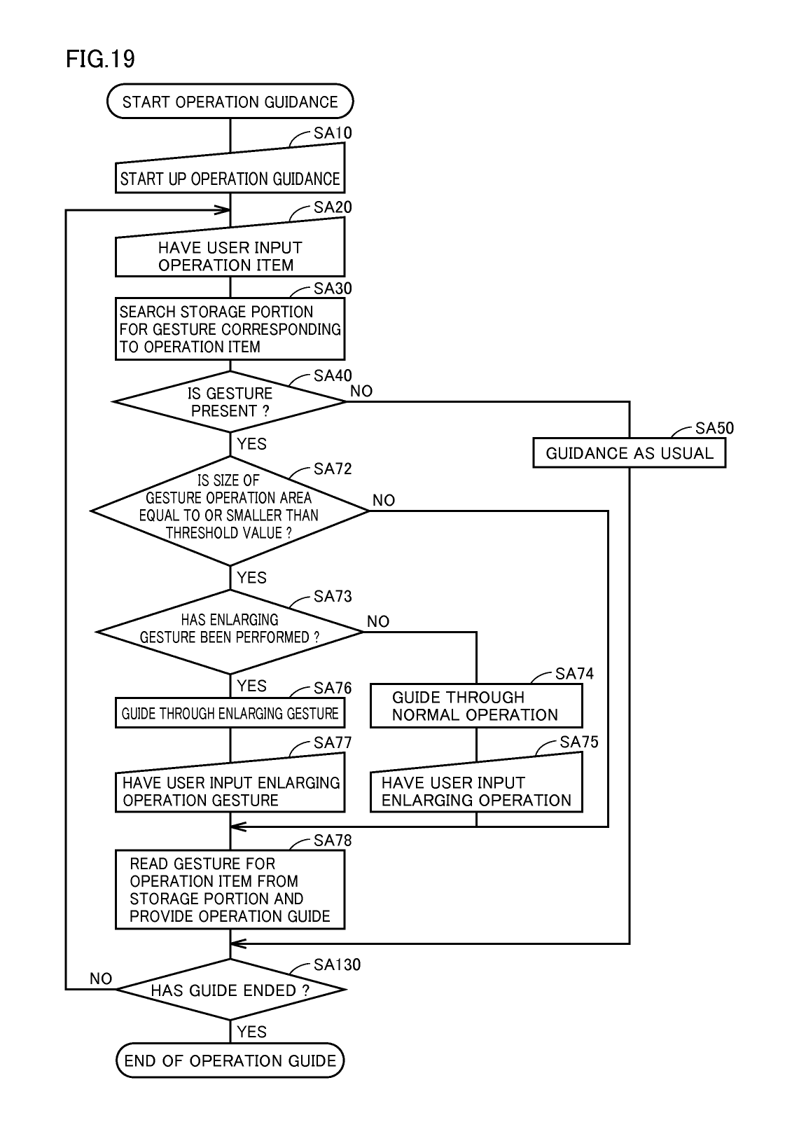

A variation of the gesture display processing will be described. FIG. 19 is a flowchart of gesture display processing performed in variation (3).

Referring to FIG. 19, in the gesture display processing in variation (3), control unit 50 performs step SA10 to step SA40 as in the gesture display processing in FIG. 9. Then, when it is determined in step SA40 that the gesture registered in the gesture registration table could be obtained as the search result of the processing in step SA30, the process proceeds to step SA72.

In step SA72, control unit 50 reads the gesture obtained as the search result from the gesture registration table, and determines whether or not an area of a region of input of the gesture is equal to or smaller than a threshold value (the specific area described above). Then, when it is determined that the area is equal to or smaller than the threshold value, the process proceeds to step SA73, and when it is determined that the area is greater than the threshold value, the process proceeds to step SA78.

In step SA73, control unit 50 determines whether or not image processing apparatus 1 has a function for enlarging a screen based on an operation on touch panel 15A. In step SA73, for example, whether or not a function capable of detecting two points simultaneously touched on touch panel 15A is available is determined. Then, when control unit 50 determines that such a function is provided, the process proceeds to step SA76, and when it determines that such a function is not provided, the process proceeds to step SA74.

In step SA76, control unit 50 guides a gesture for an operation item designated together with a gesture for enlarging (pop-up screen 372C) as described with reference to operation screen image 301N, accepts input of the gesture for enlarging in step SA77, and causes the process to proceed to step SA78.

On the other hand, in step SA74, control unit 50 provides display of the gesture of the designated operation item without providing display of the gesture for enlarging (pop-up screen 372C), as described with reference to operation screen image 301K. Then, in step SA75, an operation for enlarging a screen displaying a gesture on a portion other than touch panel 15A of operation portion 15 is accepted, and the process proceeds to step SA78.

In step SA78, control unit 50 provides operation guide using a gesture, that is, causes touch panel 15A to display a gesture in accordance with the processing in step SA70 to step SA110 in FIG. 9, and the process proceeds to step SA130.

It is noted that, when input in accordance with the gesture for enlarging is accepted in step SA77, in step SA78, control unit 50 enlarges a region where a gesture is to be displayed as described with reference to operation screen image 301V, and then provides operation guide.

In addition, when an operation for enlarging is accepted in step SA75 as well, in step SA78, control unit 50 similarly enlarges a region where a gesture is to be displayed as described with reference to operation screen image 301V, and then provides operation guide.

[Other Variations]

In image processing apparatus 1, in a case where input in accordance with a gesture registered in the gesture registration table is provided onto touch panel 15A in a state specified in the operation-allowed state within the table, an effect the same as in the case where an operation for selecting operation contents registered in association with the gesture is performed is obtained. Namely, as a result of the gesture above, image processing apparatus 1 enters a state after the operation contents have been selected. Herein, on condition that a position of input onto touch panel 15A has moved from the starting point to the end point of the registered trail without being distant from the trail registered as the gesture by a specific distance or more (or from a point within a specific distance from the starting point to a point within a specific distance from the end point), the input onto touch panel 15A has been determined as the input in accordance with the gesture above (step SA100 in FIG. 9 or the like).

It is noted that a manner of determination as to whether or not the input onto touch panel 15A is an input in accordance with the registered gesture is not limited as such. For example, in a case where a characteristic of a trail is extracted from the registered gesture and the input onto touch panel 15A includes the characteristic, the input may be determined as the input in accordance with the registered gesture. Since a known technique can be adopted for extraction of a characteristic from such a trail, detailed description will not be repeated here.

In the present embodiment described above, such operation contents as drawing a track accompanying change in position of operation on touch panel 15A have been exemplified as the registered gesture as described with reference to FIG. 4 and the like. The gesture registered in image processing apparatus 1, however, is not limited as such, and the gesture may be operation contents in which a touch position does not change (single click, double click, flick, etc.), or it may be combination of such operation contents with operation contents in which a touch position changes.

In addition, in the present embodiment, though the “gesture”, the “operation item”, and the “operation-allowed state” are stored in association with one another in the gesture registration table described with reference to FIG. 3, a form of storage thereof is not limited to a form of a table.

Moreover, among pieces of information registered in association with one another, the “operation-allowed state” may be omitted. Namely, in the image processing apparatus, at least a gesture and an operation item should only be registered in association with each other.

Furthermore, in the present embodiment, though the gesture registration table is stored in the storage portion within image processing apparatus 1, a storage location is not limited thereto. The gesture registration table may be stored in a storage medium attachable to and removable from image processing apparatus 1, a server on a network, or the like. Then, control unit 50 may write or update information in a table in such a storage medium or server, read information from the table in the server, and perform a control operation as described in the present embodiment.

It is noted that, in the present embodiment, display (presentation) of a gesture in pop-up screen 312A or the like has been provided on touch panel 15A, however, a location of presentation is not limited to touch panel 15A accepting a user's operation. If a gesture can be presented to a user, presentation (display) may be provided on a terminal owned by the user, other display devices in image processing apparatus 1, or the like. Display on the terminal owned by the user is realized, for example, by storing an address of a terminal for each user in image processing apparatus 1 and transmitting a file for presenting the gesture to the address.

According to the present disclosure, when a user selects an operation item, contents of a touch operation associated with the operation item are displayed on the operation panel of the image processing apparatus. Thus, when setting contents customized for a desired operation item are registered and the user is not aware of the setting contents, the user can recognize the setting contents through a direct operation in connection with the item “selection of the operation item.”

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus, comprising:
an image processing unit configured to realize a function for image processing;
an operation panel for accepting an operation instruction to said image processing unit; and
a processing device configured to control an operation of said image processing unit and said operation panel,
said processing device being configured to:
recognize contents of a touch operation when the touch operation is performed onto said operation panel;
obtain an operation item stored in association with the contents of the touch operation;
carry out control when the obtained operation item is selected; and
present on said operation panel, the contents of the touch operation stored in association with the obtained item.

2. The image processing apparatus according to claim 1, wherein said processing device is configured to display the contents of said touch operation on said operation panel, together with a message inviting reproduction of the contents of the touch operation.

3. The image processing apparatus according to claim 1, wherein said processing device is configured to display the contents of said touch operation on said operation panel, together with information specifying said operation item.

4. The image processing apparatus according to claim 1, wherein display of the contents of said touch operation is display of a motion picture for displaying the contents of the touch operation over time.

5. The image processing apparatus according to claim 1, wherein said processing device is configured to:
detect a speed of the touch operation when the touch operation is performed onto said operation panel and obtain an operation item stored in association with the contents and the speed of the touch operation, and
carry out control when the obtained operation item is selected.

6. The image processing apparatus according to claim 1, wherein said processing device is configured to further display contents of a touch operation for enlarging a region for displaying information relating to an operation item on said operation panel, when an area of the region is smaller than a predetermined area.

7. A method for controlling an image processing apparatus including an image processing unit configured to realize a function for image processing and an operation panel accepting an operation instruction to said image processing unit, which is performed by a computer of the image processing apparatus, comprising:
recognizing, by said computer, contents of a touch operation when the touch operation is performed onto said operation panel;
obtaining, by said computer, an operation item associated with the contents of the recognized touch operation;
carrying out, by said computer, control when obtained said operation item is selected; and
presenting, by said computer, the contents of the touch operation stored in association with said obtained operation item.

8. The method for controlling an image processing apparatus according to claim 7, further comprising causing, by said computer, said operation panel to display the contents of said touch operation, together with a message inviting reproduction of the contents of the touch operation.

9. The method for controlling an image processing apparatus according to claim 7, further comprising causing, by said computer, said operation panel to display the contents of said touch operation, together with information specifying said operation item.

10. The method for controlling an image processing apparatus according to claim 7, wherein display of the contents of said touch operation is display of a motion picture for displaying the contents of the touch operation over time.

11. The method for controlling an image processing apparatus according to claim 7, further comprising:
detecting, by said computer, a speed of the touch operation when the touch operation is performed onto said operation panel and obtaining an operation item stored in association with the contents and the speed of the touch operation; and
carrying out, by said computer, control when the obtained operation item is selected.

12. The method for controlling an image processing apparatus according to claim 7, further comprising providing, by said computer, further display of contents of a touch operation for enlarging a region for displaying information relating to an operation item on said operation panel, when an area of the region is smaller than a predetermined area.

13. A non-transitory computer-readable recording medium recording a control program executable by a computer of an image processing apparatus, said control program causing said computer to perform the method according to claim 7.

14. A non-transitory computer-readable recording medium recording a control program executable by a computer of an image processing apparatus, said control program causing said computer to perform the method according to claim 8.

15. A non-transitory computer-readable recording medium recording a control program executable by a computer of an image processing apparatus, said control program causing said computer to perform the method according to claim 9.

16. A non-transitory computer-readable recording medium recording a control program executable by a computer of an image processing apparatus, said control program causing said computer to perform the method according to claim 10.

17. A non-transitory computer-readable recording medium recording a control program executable by a computer of an image processing apparatus, said control program causing said computer to perform the method according to claim 11.

18. A non-transitory computer-readable recording medium recording a control program executable by a computer of an image processing apparatus, said control program causing said computer to perform the method according to claim 12.
